(19) United States
(12) Patent Application Publication
(10) Pub. No.: US 2004/0230945 A1
(43) Pub. Date: Nov. 18, 2004

(54) Integration of a configuration tool with a graphical program language

(76) Inventors: Deborah E. Bryant, Austin, TX (US); Brian M. Johnson, Austin, TX (US); Christopher G. Cifra, Austin, TX (US)

Correspondence Address: Jeffrey C. Hood, Meyertons, Hood, Kivlin, Kowert & Goetzel PC, P.O. Box 398, Austin, TX, 78767, US

(21) Appl. No.: 10/438,769

(22) Filed: May 15, 2003

(51) Int. Cl. G06F 9/44; G06F 9/45

(52) U.S. Cl. 717/106; 717/109; 717/144

(57) ABSTRACT

System and method for invoking code-generation functionality in a graphical programming language. User input is received to a graphical program node, e.g., a configured name control for a task or channel, where the graphical program node includes a task specification that specifies hardware and/or software for performing a task. The task specification may include channel configuration information for configuring a physical analog or digital channel of a device, and timing/triggering information. A code-generation function is invoked in response to the user input, and performed, thereby generating at least a portion of a graphical program in accordance with the task specification, where the graphical program implements the task. Based on the task specification, the function may generate example code that performs the task, configuration code executable to programmatically generate the task specification, and/or conversion code that converts the node from a first to a second type, each including the task specification.

### FIELD OF THE INVENTION

The present invention relates to the field of graphical programming, and more particularly to invocation of code-generation functionality in a graphical programming language, e.g., via integration of a configuration tool with the programming language.

### DESCRIPTION OF THE RELATED ART

Traditionally, high level text-based programming languages have been used by programmers in writing application programs. Many different high level text-based programming languages exist, including BASIC, C, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various nodes, e.g., icons such as function nodes, terminals nodes, structure nodes, etc., which represent desired functionality, and then connecting the nodes together to create the program. The nodes may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

In parallel with the development of the graphical programming model, increasingly powerful tools have been developed to facilitate the creation, management, and execution of graphical programs to perform specified functions, such as configuration tools. For example, channel and task specification tools have been developed that receive user input specifying attributes of a channel or task and generate a corresponding channel or task specification in response to the user input. The channel or task specification may then be provided as input to a graphical program node in a graphical program, e.g., to a data acquisition read or write node.

However, prior art approaches have typically separated the functionality of the configuration tool from that of the graphical programming language, for example, requiring the developer of the graphical program to specify and create task and channel specifications using a configuration tool, then create the graphical program that uses the specifications in a graphical programming language, e.g., by placement of appropriate graphical program nodes in the graphical program for receiving and using the task specification. The separation of these two aspects of the development process may unnecessarily impede the developer, reducing the efficiency of the development process.

Thus, improved systems and methods are desired for integrated use of code-generation functionality, e.g., of configuration tools, and graphical programming languages, e.g., for the creation and management of graphical programs for performing tasks, e.g., measurement, control, automation, and simulation tasks, among others.

### SUMMARY OF THE INVENTION

Various embodiments of a system and method are presented for invoking functionality, such as code-generation functionality, from a graphical programming language, e.g., during development and/or configuration of a graphical program, where the graphical program implements a task. For example, the functionality may be one or more functions of a configuration tool, where the functions may be invoked from the graphical programming language, e.g., from a graphical program node, in a manner that is transparent to a user, e.g., the user may not be aware that the functions are comprised in the configuration tool. Note that in the systems and methods described herein, the operations and functions performed by a graphical program, such as I/O, are performed in the context of a task, where the task is the functionality implemented by the graphical program. It is noted that DAQ (data acquisition) is an exemplary application of the techniques presented herein, e.g., where code-generation functionality, e.g., of a configuration tool, is invocable from, i.e., integrated with, a graphical programming language. Although the embodiments of the invention described herein are presented in the context of a DAQ application, it should be noted that the methods and techniques described are broadly applicable across a wide variety of domains and fields, including, for example, test and measurement, process or system control and automation, simulation, machine vision, and data or image processing, among others. Additionally, the methods described herein may be used in conjunction with any of a variety of computer systems or devices as desired.

First, user input may be received to a graphical program node. As is well known, a graphical program node is generally operable to be included in a graphical program, where the graphical program is executable to perform a task. In a preferred embodiment, the graphical program node includes a task specification, where the task specification specifies hardware and/or software for performing the task. It should be noted that in including the task specification, the graphical program node may actually contain the task specification, e.g., in a data structure, or alternatively, may include a reference to the task specification, e.g., whereby the task specification may be retrieved for use as needed.

Once developed, a graphical program preferably includes a plurality of interconnected nodes that visually indicate functionality of the graphical program. However, in one embodiment, when the user input is received to the graphical program node, the graphical program may be under development, and so may only include a portion or subset of the nodes that will eventually be included. For example, the graphical program may initially only include the graphical program node, e.g., a first node, for example, a task or channel name control. In one embodiment, the graphical program node is a configured node, e.g., a configured name control for a task or channel. In one embodiment, the user input to, the first node may include the user “right-clicking” on the node (i.e., on the node icon in the block diagram) using a pointing device such as a mouse. Other means of receiving user input to the node are also contemplated. It is noted that in one embodiment, the graphical program node may include a ring control, where a user may activate the graphical program node, e.g., by “left-clicking”, thereby accessing a list of available (pre-existing) task specifications, and select a desired task specification to associate with or include in the control, e.g., the channel or task name control, thereby replacing the previously assigned task specification, if any.

In one embodiment, receiving user input to the graphical program node may include receiving first user input to the graphical program node, displaying a plurality of function options to the user, where each function option indicates a respective function, and receiving second user input selecting the function, e.g., a code-generation function. For example, displaying a plurality of function options to the user may include displaying a menu of the function options, and/or displaying a dialog of the function options, among other option display techniques, where the second user input may include clicking on or otherwise indicating a presented option with a pointing device, e.g., a mouse. In one embodiment the functions may be comprised in a configuration tool, and so the second user input may select the function of the configuration tool.

A code-generation function, e.g., of the configuration tool, may be programmatically invoked in response to the user input. In other words, the code-generation function that corresponds to the selected option may be invoked in response to the user input. In a preferred embodiment, the code-generation function is operable to programmatically generate at least a portion of a graphical program.

Finally, the code-generation function may be performed, e.g., by the configuration tool, thereby programmatically generating at least a portion of a graphical program, where the graphical program implements the task in accordance with the task specification. As noted above, the task may relate to any of a variety of applications, fields, or domains, and may comprise any type of function, such as, for example, an industrial automation function, a process control function, a test and measurement function, and/or a simulation function, among others. Descriptions of various examples of code-generation functions and their invocations follow. It should be noted that the examples provided are intended to be exemplary only, and are not intended to limit the invention to any particular form, appearance, or functionality.

As noted above, in one embodiment, the graphical program node may be a configured node, such as a configured channel or task name control, that preferably includes a task specification. In one embodiment, the task specification includes specification information for one or more channels and/or timing and triggering parameters for performing the task. The timing and triggering parameters may be specified, or may be default values.

In one embodiment, the user input received to the name control invokes presentation of a menu which provides a variety of options, including a “Generate Code” option which includes a secondary “pull-right” menu providing various code generation options, each representing a respective code-generation function of the configuration tool, including, for example, “Example”, “Configuration”, and “Configuration and Example” code generation options.

Selection of the “Example” code generation option may invoke an “Example Code Generation” function, e.g., of the configuration tool, which may perform programmatic generation of a graphical program that is executable, e.g., by a graphical program execution system, to perform the specified task. In other words, a user may select this option to generate an example graphical program that performs the function specified, e.g., fully executable code that demonstrates to a user how to use a pre-configured task or channel in the graphical program development system. The user may then use the program as is, or may choose to modify the graphical program, e.g., to add further functionality, modify parameters, and so forth. The graphical program preferably implements the task in accordance with the task specification, e.g., using software and/or hardware, e.g., a device, configured per the specification information in the task specification.

In one embodiment, selection of the “Configuration” option mentioned above may invoke generation of one or more interconnected graphical program nodes implementing programmatic generation of the task specification, where, for example, the one or more interconnected graphical program nodes may be operable to be included in a graphical program, where the graphical program may be executable to perform the task in accordance with the programmatically generated task specification. In other words, the portion of the graphical program generated by the invoked function may be executable to generate the task specification at run-time, where other nodes in the graphical program, e.g., added by a user or programmatically generated by another process, e.g., via the configuration tool, may execute to perform the function in accordance with the generated (at run-time) task specification. Thus, the code-generation function may operate to generate graphical program code that is executable to programmatically generate the task specification, e.g., for provision to other portions of the graphical program. In other words, the channel name control (or task name control) includes a task specification, and the configuration code-generation function generates a graphical program portion (based on the task specification) that, at run-time, generates that task specification programmatically. This capability is particularly useful, for example, for deployment, in that the user is no longer dependent on information (the task specification) stored in a database, since the sub-VI (graphical program) creates the equivalent task specification pro grammatically.

As yet another example, the “Configuration and Example” code-generation function may be invoked, e.g., by user selection of the “Configuration and Example” option mentioned above, which may operate to generate both example graphical program code and configuration graphical program code, effectively combining the code-generation functionality described above. Thus, in this embodiment, a substantially complete graphical program may be generated that both programmatically generates the task specification at run-time, and uses the generated task specification to perform the task. Of course, the user may modify the generated graphical program as desired prior to actually performing the task.

In a further embodiment, a code conversion function may be invoked from a name control, e.g., from a task name control. For example, a “Convert to Express VI” function option may be selected, thereby invoking a corresponding function, e.g., of a configuration tool, that in one embodiment operates to perform the combined code-generation functionality described above, i.e., programmatically generating both configuration and example code, and additionally encapsulating the generated code (graphical program) in a single node, referred to herein as an “Express VI”. The encapsulating graphical program node may then be executable to perform the task in accordance with the task specification. In other words, the resulting graphical program node may serve to hide the details of the implementation from the user, although it should be noted that the entire generated graphical program is preferably still included, merely hidden.

In another embodiment, another code conversion function may be invoked that converts graphical program code from one form to another. In this embodiment, the function is invoked from a configured graphical program node that includes a task specification, and that further encapsulates a graphical program. In other words, the graphical program node may be an Express VI, as described above, or its equivalent, i.e., an encapsulating node that includes a task specification. The invoked code-generation function may operate to retrieve the task specification from the graphical program node, and generate a configured name control, such as a task or channel name control, that contains the task specification. In other words, the invoked function may operate to extract a task specification from a first configured node of a first type (e.g., an Express VI), and generate a second configured node of a second type (e.g., a configured name control) that includes the extracted task specification. Thus, if this option is selected, a new task specification may be created (with a default name, such as “NewTask0”) with the same configuration as the graphical program node, e.g., the Express VI. Note that once the conversion is performed, the resultant node, e.g., the task control, is preferably operable to receive user input and invoke various functionalities, as described above. In one embodiment, the function may also operate to store the task specification, e.g., a copy of the task specification, in a database, where the (stored copy of the) task specification is accessible for use in other graphical programs.

Thus, various code-generation functions may be invoked from a graphical program node, thereby programmatically generating at least a portion of a graphical program, where the graphical program is operable to perform a specified task, e.g., in accordance with a task specification.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a computer system operable to execute a graphical program according to an embodiment of the present invention;

FIG. 1A illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3 is a high level block diagram of an exemplary system which may execute or utilize graphical programs;

FIG. 3A illustrates an exemplary system suitable for performing control and/or simulation functions utilizing graphical programs;

FIG. 4 is an exemplary block diagram of the computer systems of FIGS. 1, 1A, 2A and 2B and 3A;

FIG. 5 is a high level flowchart diagram illustrating one embodiment of a method for integrated use of a configuration tool in a graphical programming language;

FIG. 6 illustrates invocation of a code-generation function from a graphical programming node, according to one embodiment;

FIGS. 7-9 illustrate graphical programs resulting from the function invocation of FIG. 6, according to one embodiment;

FIG. 10 illustrates invocation of another code-generation function from a graphical programming node, according to one embodiment;

FIG. 11 illustrates a graphical program resulting from the function invocation of FIG. 10, according to one embodiment;

FIG. 12 illustrates invocation of the code-generation functions of FIGS. 6 and 10 from a graphical programming node, according to one embodiment;

FIG. 13 illustrates invocation of yet another code-generation function from a graphical programming node, according to one embodiment;

FIG. 14 illustrates a graphical program and a single graphical program node that encapsulates the graphical program, according to one embodiment; and

FIG. 15 illustrates invocation of a further code-generation function from a graphical programming node, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### INCORPORATION BY REFERENCE

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

U.S. patent application Ser. No. 09/886,455 titled “System and Method for Programmatically Generating a Graphical Program in Response to User Input,” filed Jun. 20, 2001.

U.S. patent application Ser. No. 10/008,792 titled “Measurement System Software Architecture for Easily Creating High-Performance Measurement Applications,” filed Nov. 13, 2001.

U.S. patent application Ser. No. 10/008,792 titled “Measurement System Graphical User Interface for Easily Configuring Measurement Applications,” filed Apr. 24, 2002.

Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium, carrier medium, and/or programmable hardware element; encompasses various types of mediums that can either store program instructions/data structures or can be configured with a hardware configuration program.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DiaDem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, VisSim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Node—In the context of a graphical program, an element that may be included in a graphical program. A node may have an associated icon that represents the node in the graphical program, as well as underlying code or data that implements functionality of the node. Exemplary nodes include function nodes, terminal nodes, structure nodes, etc. Nodes may be connected together in a graphical program by connection icons or wires.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators

Input Control—a graphical user interface element for providing user input to a program. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more data acquisition (DAQ) or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

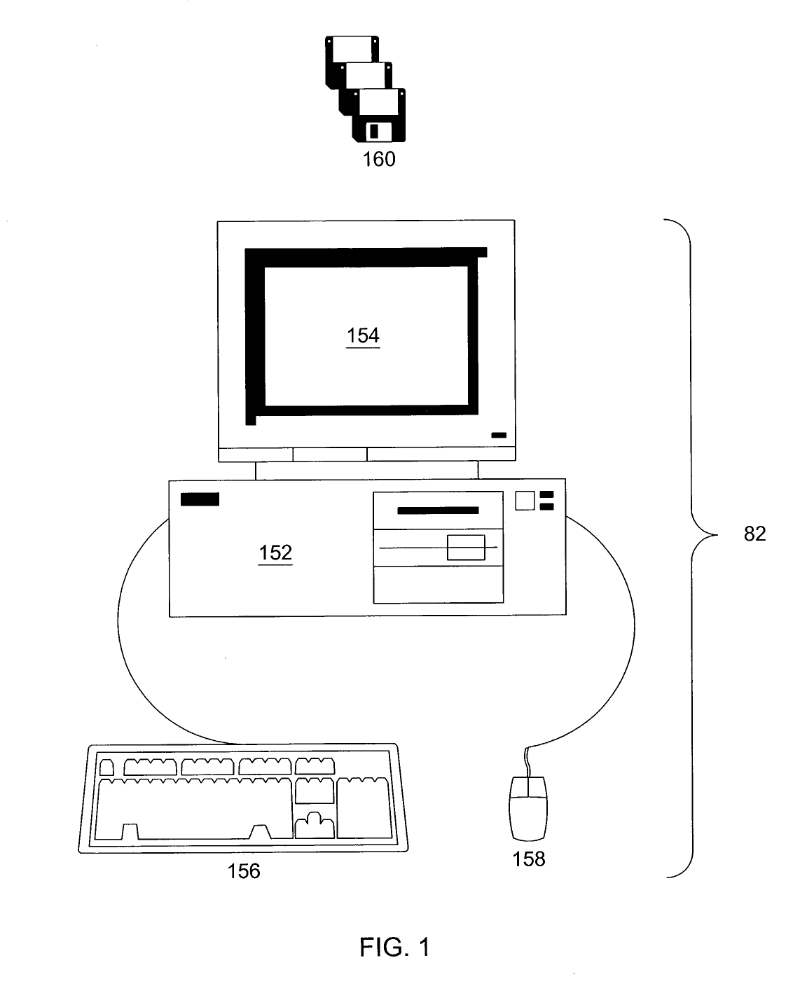

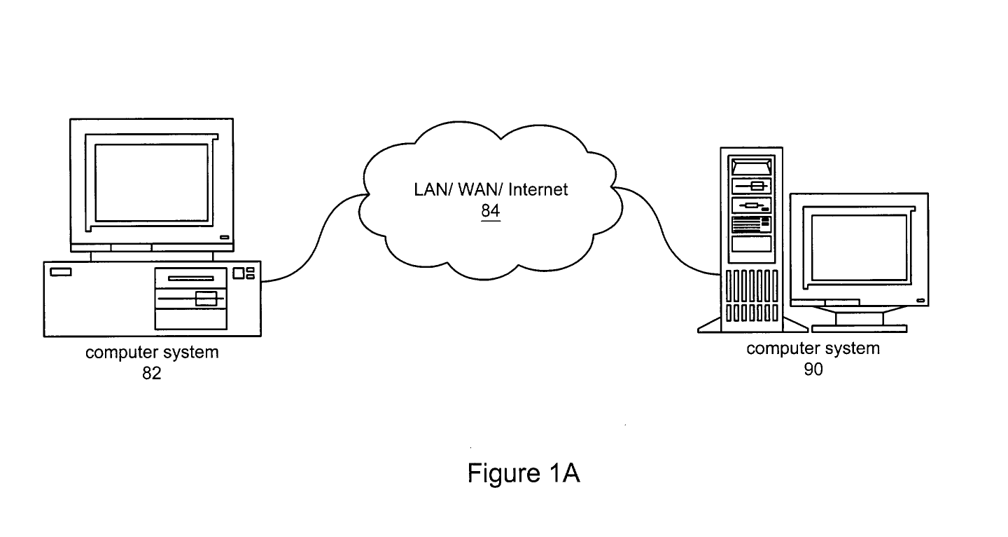

FIG. 1—Computer System

FIG. 1 illustrates a computer system 82 operable to store and execute program instructions for invoking functionality, such as code-generation functionality of a configuration tool, from a graphical programming language. One embodiment of a method for invoking code-generation functionality, e.g., of a configuration tool, from a graphical programming language is described below.

As shown in FIG. 1, the computer system 82 may include a display device 154 operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include a memory medium(s) on which one or more computer programs or software components according to one embodiment of the present invention may be stored. For example, the memory medium may store one or more programs, e.g., text based or graphical programs, which are executable to perform the methods described herein. Also, the memory medium may store a graphical programming development environment application used to create and/or execute graphical programs according to various embodiments of the present invention, and a configuration tool used to create and/or configure tasks, including generation of hardware and/or software specifications for the task, as well as programmatic code generation. The memory medium may also store operating system software, as well as other software for operation of the computer system. Various embodiments further include receiving or storing instructions and/or data implemented in accordance with the foregoing description upon a carrier medium.

FIG. 1A—Computer Network

FIG. 1A illustrates a system including a first computer system 82 that is coupled to a second computer system 90. The computer system 82 may be connected through a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device 190 connected to the computer system 82. The device 190 may include a programmable hardware element and/or may include a processor and memory medium which may execute a real time operating system. In one embodiment, the graphical program may be downloaded and executed on the device 190. For example, an application development environment with which the graphical program is associated may provide support for downloading a graphical program for execution on the device in a real time system.

Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that the present invention can be used for a plethora of applications and are not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

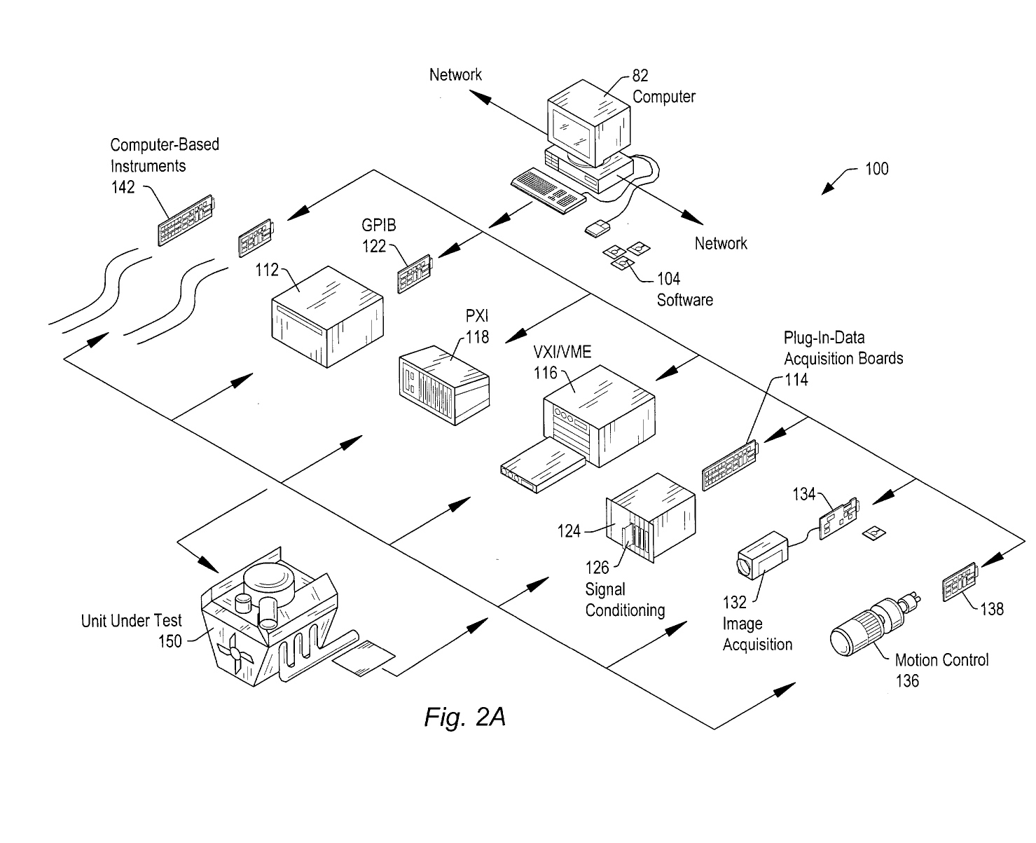

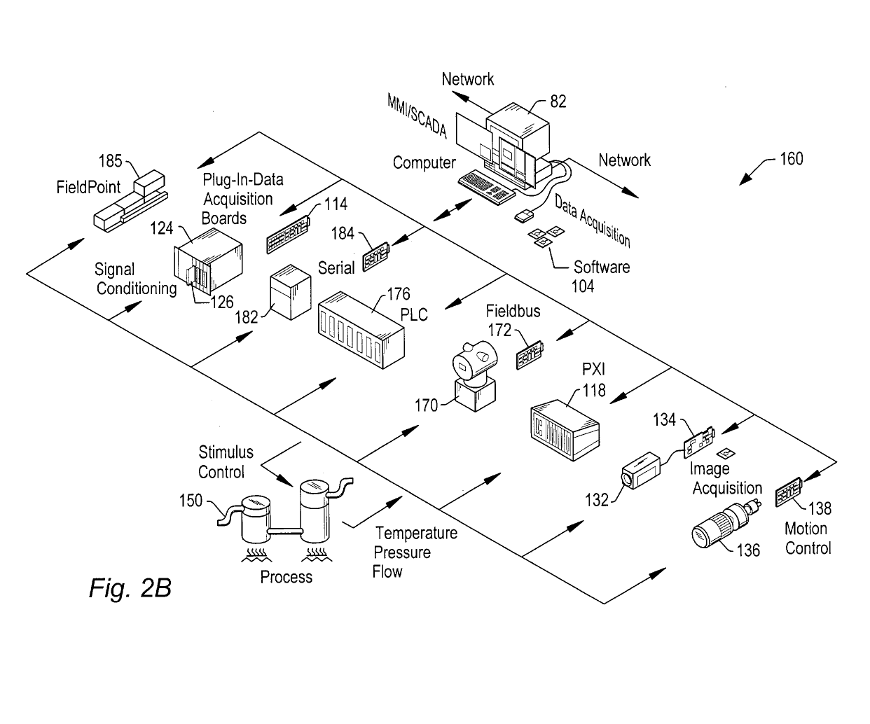

FIG. 2A illustrates an exemplary instrumentation control system 100 which may implement embodiments of the invention. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

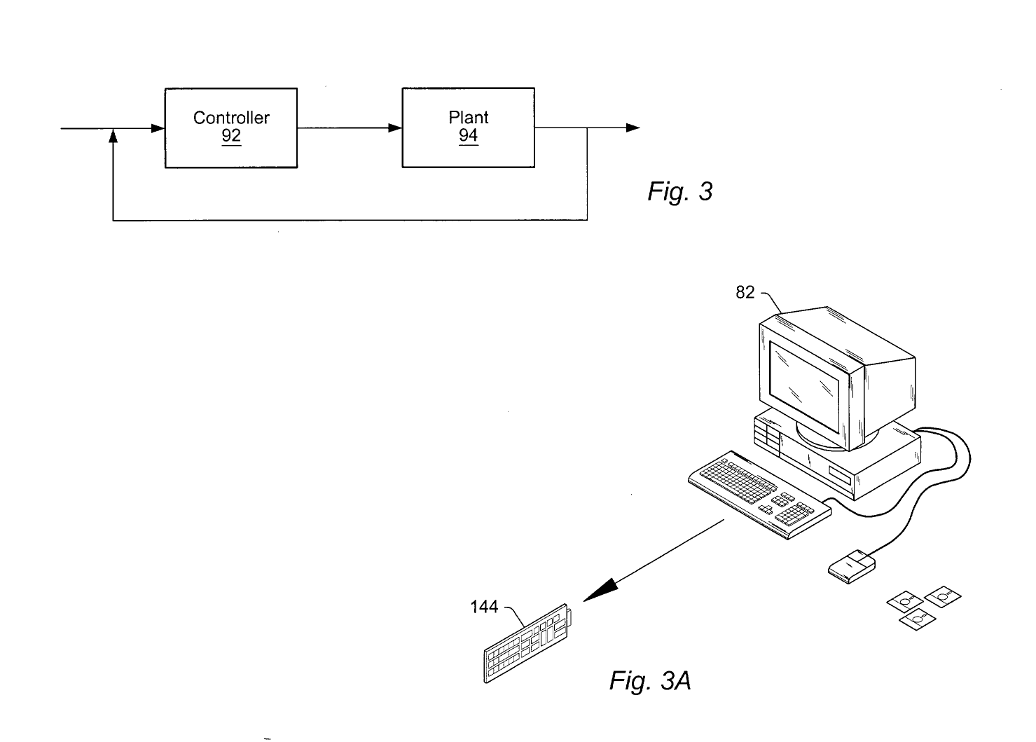

FIG. 3 is a high level block diagram of an exemplary system which may execute or utilize graphical programs. FIG. 3 illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3A illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a RTOS, or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 believe that it is connected to a real plant, e.g., a real engine.

In the embodiments of FIGS. 2A, 2B, and 3A above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A, 2B, and 2C, may be referred to as virtual instruments (VIs).

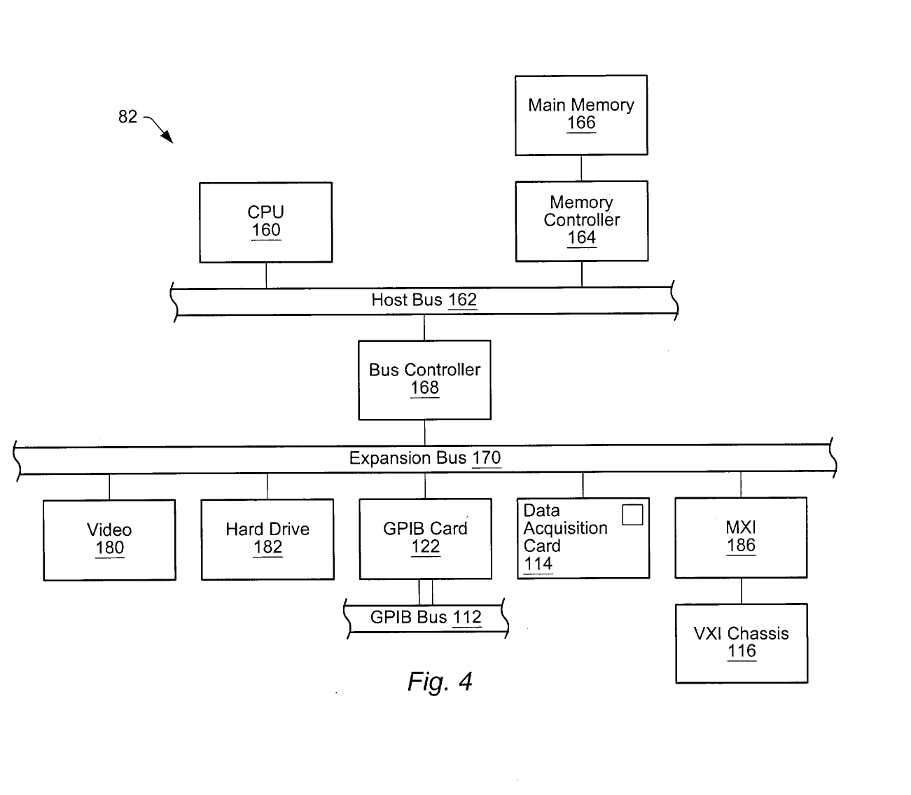

FIG. 4—Computer System Block Diagram

FIG. 4 is a block diagram representing one embodiment of the computer system 82 and/or 90 illustrated in FIGS. 1 and 1A, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store program instructions for invocation and use of a configuration tool or functionality thereof from a graphical programming language, as well as one or more graphical programs according to various embodiments of the present invention. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, various devices may also be connected to the computer. For example, as FIG. 4 shows, exemplary devices may include one or more of a video adaptor 180, a hard drive 182, a bus card, such as a GPIB card 122 and GPIB bus 112, a DAQ card 114, and an MXI card 186 coupled to a VXI chassis 116, among others. In one embodiment, a device coupled to the computer may include a processor and memory which may execute a real time operating system. The device may also or instead comprise a programmable hardware element. The computer system may be operable to deploy a graphical program to the device for execution of the graphical program on the device. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code that has generated from either the graphical program or from text code that in turn was generated from the graphical program.

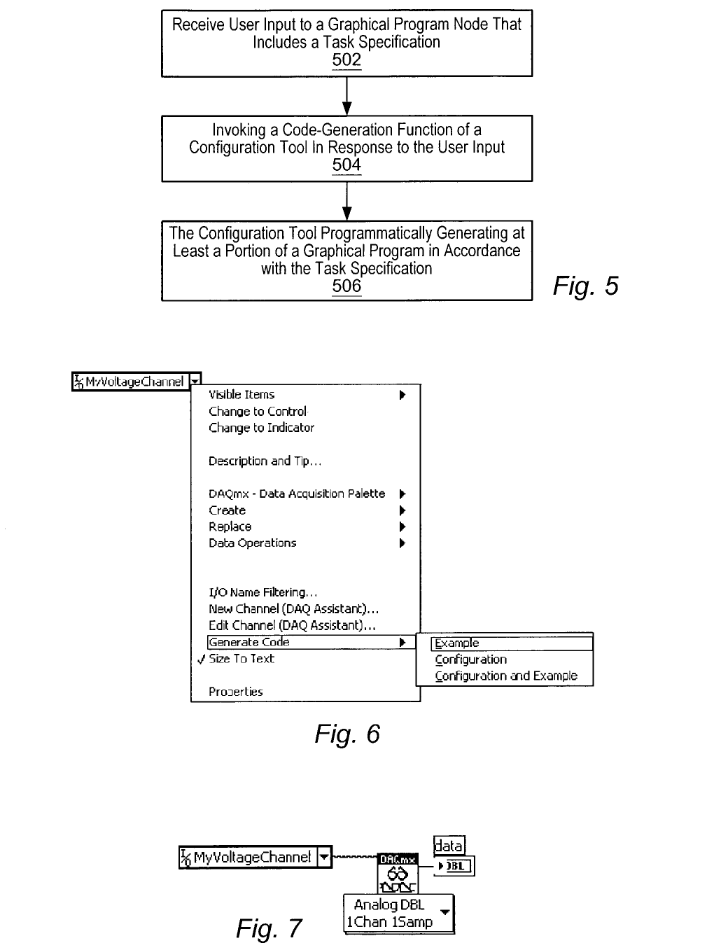

FIG. 5—Programmatically Creating and Managing a Task in a Graphical Program

FIG. 5 is a high level flowchart of a method for invoking functionality, such as code-generation functionality, from a graphical programming language, e.g., during development and/or configuration of a graphical program, where the graphical program implements a task. For example, the functionality may be one or more functions of a configuration tool, where the functions may be invoked from the graphical programming language, e.g., from a graphical program node, in a manner that is transparent to a user, e.g., the user may not be aware that the functions are comprised in the configuration tool. Note that in the systems and methods described herein, the operations and functions performed by a graphical program, such as I/O, e.g., DAQ I/O, are performed in the context of a task, where the task is the functionality implemented by the graphical program. As noted above, DAQ (data acquisition) is an exemplary application not only of graphical programming, but of the techniques presented herein as well, e.g., where code-generation functionality, e.g., of a configuration tool, is invocable from, i.e., integrated with, a graphical programming language. Although the embodiments of the invention described below are presented in the context of a DAQ application, it should be noted that the methods and techniques described herein are broadly applicable across a wide variety of domains and fields, including, for example, test and measurement, process or system control and automation, simulation, machine vision, and data or image processing, among others.

In various embodiments, one or more of the steps described may be performed concurrently, in a different order than shown, or omitted. Additional steps may also be performed as desired. The method shown in FIG. 5 may be used in conjunction with any of the computer systems or devices shown in the above Figures, among other devices. As shown, this method may operate as follows.

First, in step 502, user input may be received to a graphical program node. As noted above, a graphical program node is operable to be included in a graphical program, where the graphical program is executable to perform a task. In a preferred embodiment, the graphical program node includes a task specification, where the task specification specifies hardware and/or software for performing the task. It should be noted that in including the task specification, the graphical program node may actually contain the task specification, e.g., in a data structure, or alternatively, may include a reference to the task specification, e.g., whereby the task specification may be retrieved for use as needed.

For further information regarding task specifications and the generation thereof, please see U.S. patent application Ser. No. 10/008,792 titled “Measurement System Software Architecture for Easily Creating High-Performance Measurement Applications,” and U.S. patent application Ser. No. 10/008,792 titled “Measurement System Graphical User Interface for Easily Configuring Measurement Applications,” both of which were incorporated by reference above.

As also noted above, once developed, a graphical program preferably includes a plurality of interconnected nodes that visually indicate functionality of the graphical program. However, in one embodiment, in 502, the graphical program may be under development, and so may only include a portion or subset of the nodes that will eventually be included. For example, in 502, the graphical program may initially only include the graphical program node, e.g., a first node, for example, a task or channel name control. In one embodiment, the graphical program node is a configured node, e.g., a configured name control for a task or channel. In one embodiment, the user input to the first node may include the user “right-clicking” on the node (i.e., on the node icon in the block diagram) using a pointing device such as a mouse. Other means of receiving user input to the node are also contemplated. For example, the user may “double-click” on the node, “hover” the cursor over the node, or otherwise provide user input to the node via any means desired. It is noted that in one embodiment, the graphical program node may include a ring control, where a user may activate the graphical program node, e.g., by “left-clicking”, thereby accessing a list of available (pre-existing) task specifications, and select a desired task specification to associate with or include in the control, e.g., the channel or task name control, thereby replacing the previously assigned task specification, if any.

In one embodiment, receiving user input to the graphical program node may include receiving first user input to the graphical program node, displaying a plurality of function options to the user, where each function option indicates a respective function, and receiving second user input selecting the function, e.g., a code-generation function. For example, displaying a plurality of function options to the user may include displaying a menu of the function options, and/or displaying a dialog of the function options, among other option display techniques, where the second user input may include clicking on or otherwise indicating a presented option with a pointing device, e.g., a mouse. As noted above, in one embodiment the functions may be comprised in a configuration tool, and so the second user input may select the function of the configuration tool.

In 504, a code-generation function, e.g., of the configuration tool, may be programmatically invoked in response to the user input. In other words, the code-generation function that corresponds to the selected option of 502 may be invoked in response to the user input. In a preferred embodiment, the code-generation function is operable to programmatically generate at least a portion of a graphical program.

Finally, in 506, the code-generation function may be performed, e.g., by the configuration tool, thereby programmatically generating at least a portion of a graphical program, where the graphical program implements the task in accordance with the task specification. As noted above, the task may relate to any of a variety of applications, fields, or domains, and may comprise any type of function, such as, for example, an industrial automation function, a process control function, a test and measurement function, and/or a simulation function, among others. In one embodiment, in 506 the code-generation function may generate one or more, or a plurality of, interconnected nodes which are coupled to the graphical program node (e.g., the first node) of 502 above. In another embodiment, the code-generation function may generate a plurality of interconnected nodes which are “behind” the graphical program node (e.g., the first node) of 502 above, i.e., the first node may be programmatically configured as a sub-program node that represents the plurality of interconnected nodes (the plurality of interconnected nodes being a sub-program of the first node).

The method may be implemented and performed in a variety of ways, some of which are described in more detail below with reference to FIGS. 6-15.

FIGS. 6-15—Examples

FIGS. 6-15 illustrate various examples illustrating embodiments of the method of FIG. 5. It should be noted that the examples provided are intended to be exemplary only, and are not intended to limit the invention to any particular form, appearance, or functionality.

In one embodiment, the graphical program node may be a configured node, such as a configured name control. As noted above, the configured name control preferably includes a task specification. In one embodiment, the task specification includes specification information for one or more channels and/or timing and triggering parameters for performing the task.

For example, in one embodiment, the configured name control may be a channel name control, as illustrated in FIG. 6, where the channel name control is labeled “I/O MyVoltageChannel. In this embodiment, the task specification includes a channel specification and default timing and triggering parameter values for performing the task, e.g., acquire a single sample immediately, no triggering. Of course, these default values may be over-ridden as desired, for example, either prior to program execution, e.g., manually, or programmatically at run-time. The channel specification may include channel configuration data for configuring a physical channel of a device for use in performing the task. For example, in a measurement application, the device may be a DAQ device that may operate to acquire and provide data over the specified channel, where the channel is configured in accordance with the channel configuration data. It is noted that the physical channel may be an analog channel or a digital channel. In the embodiment of FIG. 6, the channel is configured to acquire data from a voltage signal, e.g., an analog voltage signal.

As FIG. 6 shows, in this embodiment, the user input received to the channel name control invokes presentation of a menu which provides a variety of options, including a “Generate Code” option which includes a secondary “pull-right” menu providing various code generation options, each representing a respective code-generation function, e.g., of the configuration tool, including “Example”, “Configuration”, and “Configuration and Example” code generation options. As FIG. 6 also shows, in this example, the “Example” code generation option has been selected, e.g., by additional user input, thereby invoking an “Example Code Generation” function, e.g., of the configuration tool. Examples of generated “Example Code” are illustrated in FIGS. 7-9 and described below. It should be noted that the particular code generation options presented in FIG. 6 are meant to be exemplary only, and are not intended to limit the code-generation functions or functionality to any particular forms or functions. Additionally, in some embodiments, rather than being comprised in a configuration tool, the function or functions may be comprised in the program development environment, execution system, or other system associated with the graphical program. More detailed descriptions of the code-generation functions and their outputs are described below.

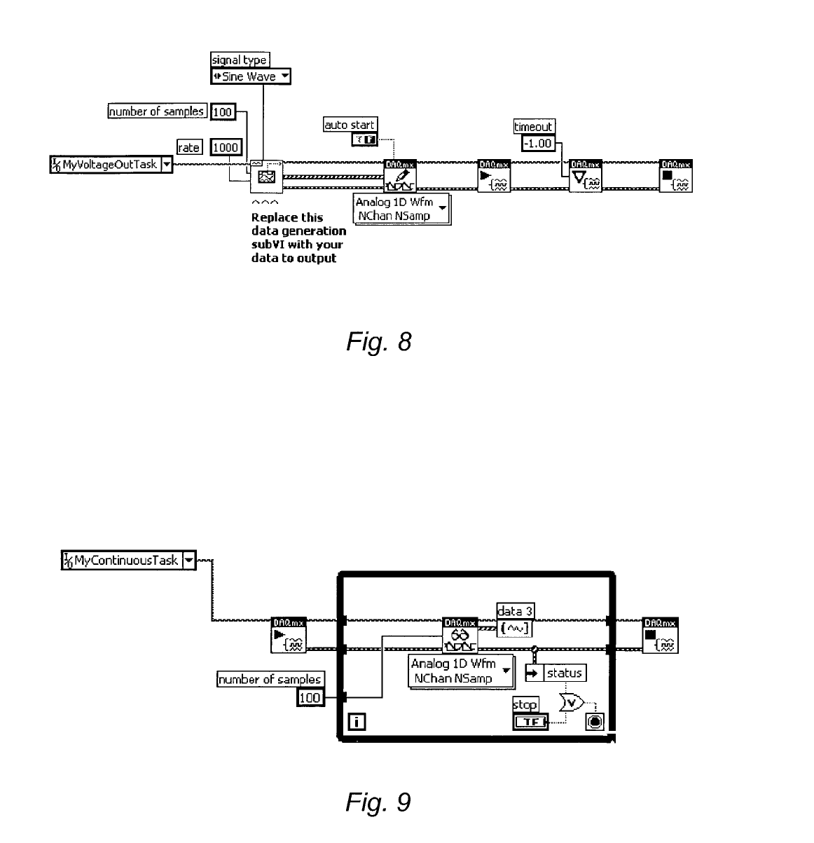

In another embodiment, the configured name control may be a task name control, where the task specification includes one or more channel specifications and timing and triggering parameter values for performing the task, and where each channel specification includes channel configuration data for configuring a physical channel of a device for use in performing the task, as mentioned above. Note that the primary difference between the task specification included in the channel name control and that of the task name control is that in the channel name control case, the timing and triggering parameters are set to default values. Examples of generated “Example Code” from task name controls are illustrated in FIGS. 8 and 9 and described below.

Thus, in one embodiment, the code-generation function may be an example code-generation function. Note that in the example given, the option “Example” refers to programmatic generation of a graphical program that is executable, e.g., by a graphical program execution system, to perform the specified task. In other words, a user may select this option to generate an example graphical program that performs the function specified, e.g., fully executable code that demonstrates to a user how to use a pre-configured task or channel in the graphical program development system, e.g., LabVIEW. The user may then use the program as is, or may choose to modify the graphical program, e.g., to add further functionality, modify parameters, and so forth. Alternatively, the user may simply wish to view the example code as a learning exercise.

Thus, when this code-generation option is selected, generating the at least a portion of the graphical program in accordance with the task specification may include generating one or more interconnected graphical program nodes, where the graphical program node and the one or more interconnected graphical program nodes comprise a graphical program. The graphical program preferably implements the task in accordance with the task specification. In other words, the graphical program is executable to perform the task as specified in the task specification, e.g., using software and/or hardware, e.g., a device, configured per the specification information in the task specification.

As noted above, the graphical program may include various types of nodes, and so the one or more interconnected graphical program nodes implementing the task may include one or more of: one or more function nodes, one or more terminal nodes, and one or more structure nodes, among other types of graphical program nodes. Similarly, many different types of function nodes are contemplated, and so, for example, the one or more function nodes may include one or more of: a read node for acquiring data from an external system or process, a write node for writing data to the external system or process, and an analysis node for analyzing data acquired during performance of the task, among others. The one or more structure nodes may include one or more of: a while loop, a for loop, a conditional, and a case/switch structure, among other types of structure node. In other words, the various nodes that may be used in a graphical program may include any functionality that may be implemented in text based programming languages, as well as functionality specific to the graphical nature of the graphical programming language.

FIG. 7 illustrates a simple example graphical program generated in response to the function invocation of FIG. 6. As FIG. 7 shows, the graphical program includes the original configured channel name control coupled to a function node, in this case, a read node, labeled “Analog DBL 1Chan 1Samp”, operable to acquire data on an analog channel from a voltage source. Note that, as the label indicates, the read node is configured to acquire 1 sample on a single channel, e.g., per the default timing and triggering specifications included in the task specification, as described above. The graphical program also includes a terminal node coupled to the read node, where the terminal node operates to provide the acquired data to a display, e.g., to an indicator on a control panel that is then displayed on a display device, e.g., a computer monitor. Thus, in the case of a simple analog input voltage channel, selecting the “Example” option may programmatically add a DAQ Read VI and an indicator displaying the data, where the new icons are automatically connected to the name control.

The generated code is not limited to a single function or node, e.g., the read node of FIG. 7. FIG. 8 illustrates one embodiment of a more complex generated graphical program resulting from invocation of the “Example” code generation option from a task name control, labeled “MyVoltageOutTask” as shown. In this example, the task specification included (via containment or by reference) by the task name control specifies a finite analog output signal generation. As noted above, in one embodiment, the task name control may have been configured using the configuration tool, or by other means. Note that this generated example graphical program includes a write node, labeled “Analog 1D Wfm NChan NSamp”, as well as terminal nodes indicating timing and triggering information specified in the task specification. In this example, the number of samples to be acquired is set to a value of 100, and the sample rate set to a value of 1000 (samples per second).

As FIG. 8 also shows, the generated graphical program also includes a “data generation” node that provides a “default” sine wave as a sample waveform for the signal generation. Note that in this example, the graphical program is annotated, indicating that the user should substitute an actual desired waveform generator (e.g., waveform data) for the supplied sine wave. Other nodes are also provided, such as a start (play) node, signified by a right-pointing triangle, a “Wait Until Done” node, signified by a down-pointing hollow triangle, and a stop node, signified by a solid square, where the start and stop nodes facilitate or control starting and stopping the task, respectively. Note that the inclusion of the start node is consonant with the specification of the write node, in that the “auto start” attribute is set to “false”, and so the start node is provided for this functionality.

Note that as the task performed by this program is an analog output, there are a number of things to be done before the task is actually started. The first node from the left (the task name control) is, or provides, the task specification. The second node, the data generation node, is simply generating a sample waveform, and has nothing to do with performing the actual task, being just example data that a user can run “out-of-the-box”. The write node performs a write function, filling a buffer (on the hardware) with the data provided by the data generation node. Note that the buffer must be filled first, before the task can be started. Once the buffer is filled, the task may be started, and the board begins operation. The fourth node, the “Wait Until Done” node, simply waits until the analog signal has been output, i.e., the buffer is empty, then passes control to the last node, the stop node, that stops the task, e.g., un-reserves the hardware and performs any other clean-up operations associated with task termination.

FIG. 9 illustrates one embodiment of a generated graphical program that includes a structure node. More specifically, FIG. 9 illustrates example code generated based on a task specification included in a task name control, shown labeled “I/O MyContinuousTask”, indicating continuous acquisition of data. Thus, in this embodiment, an “example” code-generation function was invoked from the task name control, which then programmatically generated the graphical program shown in FIG. 9.

As FIG. 9 shows, the task name control is coupled to various additional nodes generated by the invoked function, including, a start node, indicated by a right-pointing solid triangle, with a corresponding stop node, indicated by a solid square, as well as a terminal node specifying the number of samples to be acquired to be 100, a read node as described in the graphical program of FIG. 8, a display terminal labeled “data 3” for displaying acquired data on a display, and a status node coupled to a stop terminal. As FIG. 9 also shows, a structure node is also included that controls iterative execution of the read node. In this particular example, the structure node is a loop structure node, i.e., a “while loop”, which iterates in accordance with iteration index “i” as shown in the bottom left of the loop. Thus, in the case of continuous tasks (in this case, a continuous analog input), the example code may include a loop and a “stop” button to allow the user to terminate the loop.

It should be noted that this while loop structure node is exemplary only, and that other structure nodes are also contemplated, including for loops, conditionals, and switch/case structures, among others, as noted above.

In one embodiment, the code-generation function includes a configuration code-generation function. In this case, generating the at least a portion of the graphical program in accordance with the task specification may include generating one or more interconnected graphical program nodes implementing programmatic generation of the task specification. For example, the one or more interconnected graphical program nodes implementing programmatic generation of the task specification may be operable to be included in a graphical program, where the graphical program may be executable to perform the task in accordance with the programmatically generated task specification. In other words, the at least a portion of the graphical program generated by the invoked configuration code-generation function may be executable to generate the task specification at run-time, where other nodes in the graphical program, e.g., added by a user or programmatically generated by another process, e.g., via the configuration tool, as described above, may execute to perform the function in accordance with the generated (at run-time) task specification.

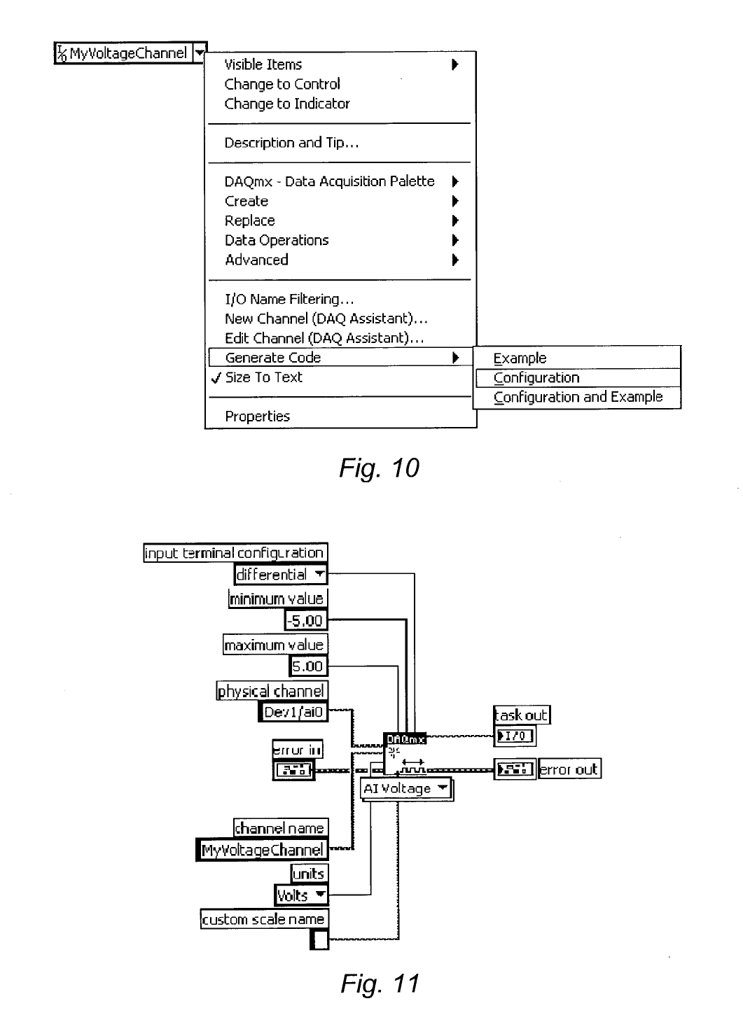

FIG. 10 illustrates invocation of another code-generation function, according to one embodiment. In this example, a “Configuration” code-generation function is invoked from the channel name control (labeled “I/O MyVoltageChannel”), e.g., by user selection of the “Configuration” option from the present menu (e.g., where the menu was invoked by right-clicking on the channel name control, or by other means). The configuration code-generation function may operate to generate graphical program code, i.e., at least a portion of a graphical program, that is executable to programmatically generate the task specification, e.g., for provision to other portions of the graphical program. In other words, the channel name control includes a task specification, and the configuration code-generation function generates a graphical program portion (based on the task specification) that, at run-time, generates that task specification programmatically.

Thus, instead of, or in addition to, generating example code, in one embodiment, a user may right-click on (or otherwise provide input to) a name control (which references a configured task or channel, e.g., stored in a database) and generate “configuration” code. This operation replaces the name control with an automatically generated graphical program portion or sub-VI that contains all of the functions (nodes and interconnections) necessary to create an equivalent task specification. This capability is particularly useful, for example, for deployment, in that the user is no longer dependent on information (the task specification) stored in a database, since the sub-VI (graphical program) creates the equivalent task specification programmatically.

FIG. 11 illustrates one embodiment of such a graphical program portion or sub-VI, executable to generate a task specification for a finite voltage acquisition, where the configuration function was invoked from the channel name control of FIG. 10. As FIG. 11 shows, a plurality of terminal nodes specifying various attributes for a named channel are coupled to a channel creation node, labeled “AI Voltage”, which may be operable to configure a voltage measurement on a first analog input channel (ai0) of a first device (Dev1). In other words, the terminals shown may provide specified parameter values to the channel creation node, which may then operate to create a channel specification which may be used to configure the channel, where the channel specification is included in a generated task specification. In this embodiment, the generated task specification may be output via a “task out” terminal node, as shown. Thus, the channel creation node may programmatically generate a task specification that includes a channel specification per the attributes provided by the terminal nodes. As mentioned above, the task specification generated by invocation from a channel name control preferably includes default timing and triggering information for the task. It should be noted that in an embodiment where the name control is a task name control, the generated configuration code preferably includes additional terminals that specify timing and triggering attributes for the task, i.e., for a task, the resulting VI will preferably also include other functions for configuring timing and triggering

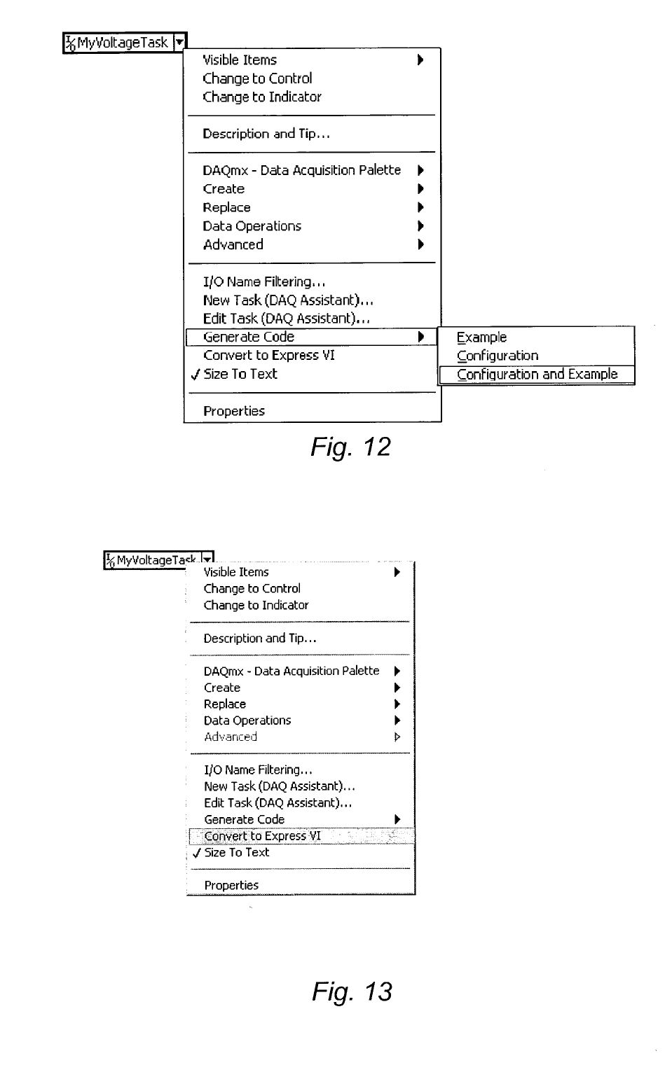

The generated configuration code may be included in a graphical program that operates to perform the task in accordance with the generated task specification, including, for example, a read node, etc., where at run-time the configuration code executes to programmatically create and provide the task specification to other portions of the graphical program, e.g., the read node. The inclusion of the configuration code in the graphical program may be performed manually, e.g., by the user, or may be included programmatically, as indicated by yet another code-generation option, shown in FIG. 12, and described below.

FIG. 12 illustrates invocation of yet another code-generation function, according to one embodiment. In this example, a “Configuration and Example” code-generation function is invoked from the channel name control (labeled “I/O MyVoltageChannel”), e.g., by user selection of the “Configuration and Example” option from the present menu (e.g., where the menu was invoked by right-clicking on the channel name control). The selected code-generation function may operate to generate both example graphical program code and configuration graphical program code, effectively combining the code-generation functionality described above with reference to FIGS. 6-11. In other words, in this embodiment, a first portion of a graphical program is generated that is executable to programmatically generate the task specification, e.g., for provision to a second portion of the graphical program that is also programmatically generated in accordance with the task specification. Thus, in this embodiment, a substantially complete graphical program may be generated that both programmatically generates the task specification at run-time, and uses the generated task specification to perform the task. Of course, the user may modify the generated graphical program as desired prior to actually performing the task. For example, if the task involved a signal generation, the user may need to replace a default waveform generation (e.g., the sine wave of FIG. 8) with a waveform appropriate for the task.

Thus, the code-generation function may include an example code-generation function and a configuration code-generation function, and so generating the at least a portion of the graphical program in accordance with the task specification may include generating one or more interconnected graphical program nodes implementing programmatic generation of the task specification, and generating one or more interconnected graphical program nodes implementing the task in accordance with the task specification. In other words, both of the functionalities described above may be invoked, where the one or more interconnected graphical program nodes implementing programmatic generation of the task specification and the one or more interconnected graphical program nodes implementing the task include a plurality of interconnected graphical program nodes composing the graphical program. Said another way, the respective portions of the graphical program generated by each function may be programmatically combined to form the complete graphical program.

FIG. 13 illustrates a further example of a code-generation function invocation, according to one embodiment. In the embodiment of FIG. 13, a code conversion function is invoked from a name control, e.g., from the task name control described above with reference to FIG. 12. In this example, a “Convert to Express VI” function option has been selected, thereby invoking a corresponding function, e.g., of a configuration tool, that in one embodiment operates to perform the combined code-generation functionality described with reference to FIG. 12, i.e., programmatically generating both configuration and example code, and additionally encapsulating the generated code (graphical program) in a single node, referred to herein as an “Express VI”, described below. The encapsulating graphical program node may then be executable to perform the task in accordance with the task specification. In other words, the resulting graphical program node may serve to hide the details of the implementation from the user, although it should be noted that the entire generated graphical program is preferably still included, merely hidden.

Express VI

As noted above, in one embodiment, the encapsulating node may be an “Express VI” or its equivalent. In one embodiment, the “Express” node may have one or more of the following attributes:

1. The node may contain all configuration and example code, scripted inside a single sub-VI that is fully executable to perform the given task as specified by the task specification.

2. In addition to the configuration code that programmatically generates the task specification, the node may also contain the original task specification, stored locally. This local copy of the task specification may be used for: 1) restoring/re-editing the task, e.g., using a configuration tool, and/or 2) converting the Express VI into a task name control, among other uses.

3. There is preferably only a single instance of this node and the task specification on the computer. If this node is copy/pasted, both a copy of the node (with configuration and example code), and a copy of the original task specification may be generated. Because of this, the task specification may not be shared between applications. In other words, the task specification is local. Thus, tasks created with this node may not be available or accessible to other users or process, e.g., they may not appear anywhere on the user's system.

4. The user may be limited to the code provided (encapsulated), and may not be allowed to change it.

Task Name Control Node

As also noted above, in one embodiment, the graphical program node may be a name control (or its equivalent), such as a task name control node. For example, in one embodiment, the name control may have one or more of the following attributes:

1. The name control may provide access to all tasks configured and saved in a database, e.g., configured and saved with National Instruments Corporation's Measurements and Automation Explorer (MAX) program.

2. The name control may contain no working code, and may optionally not contain task specifications. In other words, this node may simply provide a look-up listing of tasks that are already specified.

3. Right clicking on (or otherwise providing input to) this node may invoke options for code generation, editing of an existing task specification, or creation of a new task specification. Any new or modified task specifications may be automatically (or manually) stored in a database, e.g., MAX. Note that because these tasks are global to MAX (versus local to a single LabVIEW VI), they may be shared between VIs, and even between applications, such as, for example, tools and environments such as National Instruments Corporation's CVI and Measurement Studio, among others.

One motivation for invoking this type of conversion is if the user does not particularly need the flexibility of using a global-based task system, and wants a quick easy way to program using only a single node. Thus, if the task name control is converted to an express node, a copy of the task specification may be generated and stored with the express node. All the code necessary is then programmatically generated, resulting in a configured express node.

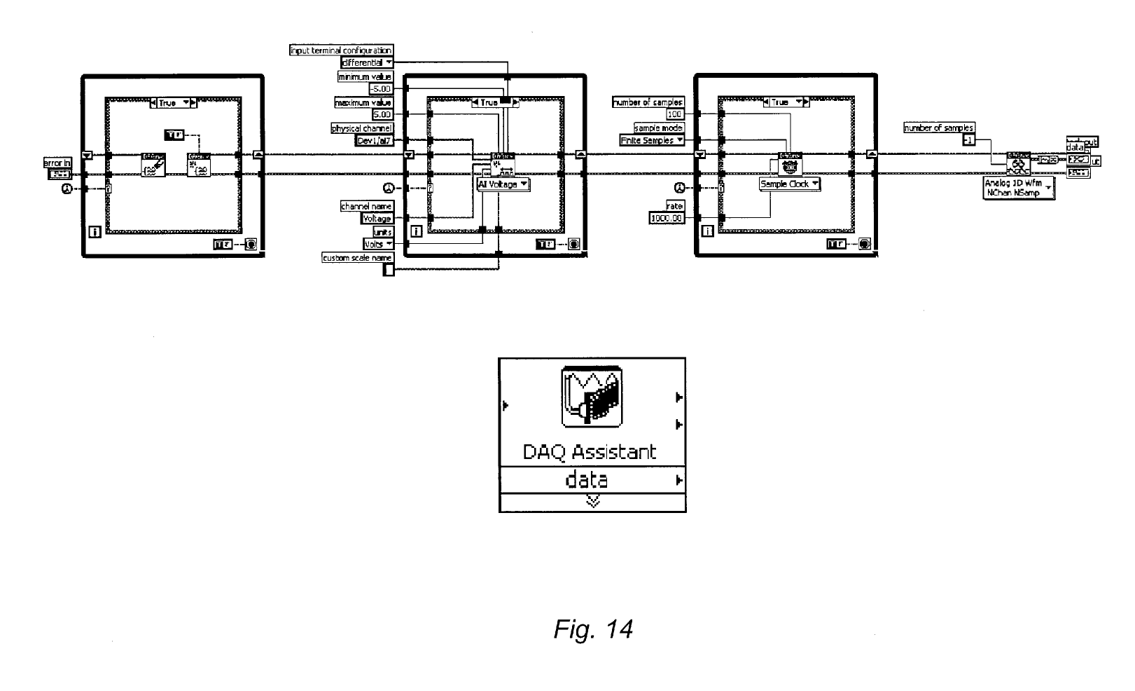

FIG. 14 illustrates encapsulation of a graphical program, e.g., generated in response to the function selection shown in FIG. 13, where the graphical program is substantially more complex than the examples provided earlier. As FIG. 14 shows, this graphical program includes three loop structure nodes (while loops), each with a corresponding conditional structure node. Note the channel terminals that provide channel configuration information to a channel creation node in the middle structure node block, as well as the timing and triggering terminals providing timing and triggering information to a sample clock node in the third structure node block (the first structure node block executes to create the task specification if it does not already exist). Thus, the majority of the graphical program shown in FIG. 14 is configuration code, as described above, while the example code includes the read node and display terminal at the far right of the block diagram. As FIG. 14 also shows, a single graphical program node (the Express VI) is presented that is the result of the encapsulation function performed after programmatic generation of the example and configuration graphical program code. Note that the term “Express VI” is an exemplary term for the node, and is not intended to limit the encapsulating graphical program node to any particular form or function.

Thus, in one embodiment, the method of FIG. 5 may include encapsulating the graphical program in a single graphical program node, where the single graphical program node represents the functionality of the graphical program, and where the single graphical program node may be executable to perform the task in accordance with the task specification.

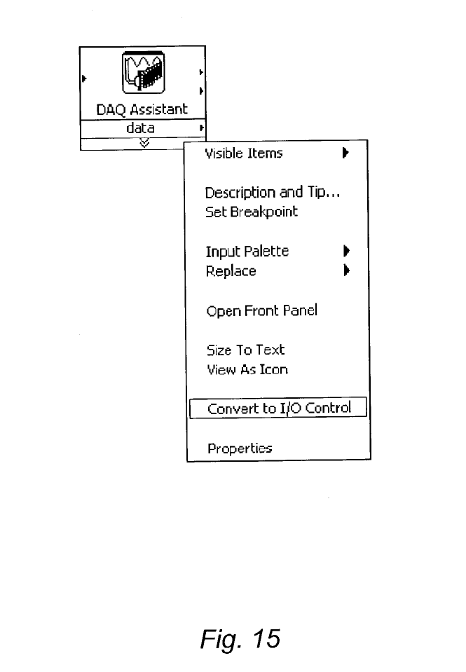

FIG. 15 illustrates invocation of yet another code-generation function that converts graphical program code from one form to another. In this embodiment, the menu is invoked by right-clicking on a configured graphical program node, where the node includes a task specification, and where the node further encapsulates a graphical program. In other words, the graphical program node may be an Express VI, as described above with reference to FIGS. 13 and 14, or its equivalent, i.e., an encapsulating node that includes a task specification. As FIG. 15 shows, the code-generation option selected in this example is a “Convert to I/O Control” function option that invokes a function, e.g., a configuration tool function, that operates to retrieve the task specification from the graphical program node, and generate a configured name control, such as a task or channel name control, that contains the task specification. In other words, the invoked function may operate to extract a task specification from a first configured node of a first type (e.g., an Express VI), and generate a second configured node of a second type (e.g., a configured name control) that includes the extracted task specification. Said another way, the function may operate to convert the first node containing the task specification to the second node, also containing the task specification.

As noted above, a task name control is substantially less functional (by itself) than an Express node, in that a task name control node cannot be run or executed by itself, i.e., other code is needed to execute the task. The advantage of converting from an Express node to a task name control node is increased flexibility. For example, tasks may be shared between applications, and the user has more control over execution of the task. Example code may be generated, as described above, and the user may then customize this code as desired. Thus, ease of use may be traded for increased flexibility.

Thus, if this option is selected, a new task specification may be created (with a default name, such as “NewTask0”) with the same configuration as the graphical program node, e.g., the Express VI. In the embodiment shown, the Express VI is replaced with a task control, e.g., a DAQmx task control, such as the task controls shown in FIGS. 7-10, and the new task's name is inserted into this control. Note that once the conversion is performed, the resultant node, e.g., the task control, is preferably operable to receive user input and invoke various functionalities, as described above.

In one embodiment, the function may also operate to store the task specification, e.g., a copy of the task specification, in a database, where the (stored copy of the) task specification is accessible for use in other graphical programs. For example, the first node may be deployed on a user's system, or may otherwise be in the user's possession, where the included task specification has been “custom” configured for a particular application. In this case, the task specification may be considered a “local” task specification, and may only be accessible by the user's application code. When the function operates to store the extracted task specification in a database, the task specification is effectively made into a global task specification available to other systems for use. For example, a name control that is implemented as a ring control, as described above, may allow a second user (or anyone else) to select the stored task specification, thereby configuring that name control to include (contain or reference) the task specification.

As mentioned above, the graphical program may be executed to perform the task in accordance with the task specification using the specified hardware and/or software. In one embodiment, the graphical program includes a block diagram portion and a user interface portion, as described above. Both portions may operate on the same computer, or alternatively, during execution of the graphical program, the graphical user interface may be displayed on a display of a first computer system and the block diagram may execute on a second computer system (or programmable hardware element).

In the embodiments described above, the graphical program node (from which the code-generation functionality is invoked) may be provided by various means. For example, the node may have been configured with a task specification at some prior time and place and stored in a database, and retrieved for use by the method. In one embodiment, the graphical program node may be generated using other functionality of the configuration tool (or by a different configuration tool).

For example, in one embodiment, the graphical program node may be (may start out as) an un-configured node. First user input may be received to the un-configured node, thereby invoking the configuration tool in response to the first user input. For example, in one embodiment, the first user input may include the user “dragging and dropping” the node from a palette onto a block diagram or a window operable to display a block diagram. Second user input may be received to the configuration tool specifying the task, where the configuration tool configures the un-configured node in response to the second user input, thereby generating a task specification included in the configured node.

In other words, the configuration tool may be invoked via an un-configured graphical program node, and used to specify the task specification, thereby configuring the node to include (contain or include a reference to) the task specification. The (now) configured graphical program node may then be used as described above, where receiving user input to the graphical program node includes receiving the user input to the configured node, and generating at least a portion of a graphical program may be performed in accordance with the generated task specification. For more information regarding the use of a configuration tool to specify a task specification and/or to configure a graphical program node, please see U.S. patent application Ser. No. 09/886,455 titled “System and Method for Programmatically Generating a Graphical Program in Response to User Input,” U.S. patent application Ser. No. 10/008,792 titled “Measurement System Software Architecture for Easily Creating High-Performance Measurement Applications,” and U.S. patent application Ser. No. 10/008,792 titled “Measurement System Graphical User Interface for Easily Configuring Measurement Applications,” all of which were incorporated by reference above.

It should be noted that the task to be performed by the graphical program may include any type of functionality desired, including, for example, an industrial automation function, a process control function, a test and measurement function, and/or a simulation function, among others. As noted above, the graphical program may operate to perform the task in conjunction with one or more devices, e.g., DAQ devices, motion controllers, etc.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A medium which is configurable to perform:
receiving user input to a graphical program node, wherein the graphical program node comprises a task specification that specifies hardware and/or software for performing a task;
invoking a code-generation function in response to the user input; and
performing the code-generation function, thereby generating at least a portion of a graphical program in accordance with the task specification, wherein the graphical program implements the task in accordance with the task specification.

2. The medium of claim 1, wherein the graphical program node comprises a configured name control.

3. The medium of claim 2, wherein the configured name control comprises a channel name control, wherein the task specification comprises a channel specification and default timing and triggering parameter values for performing the task, and wherein the channel specification comprises channel configuration data for configuring a physical channel of a device for use in performing the task.

4. The medium of claim 3, wherein the physical channel comprises one of:
an analog channel; and
a digital channel.

5. The medium of claim 2, wherein the configured name control comprises a task name control, wherein the task specification comprises one or more channel specifications and timing and triggering parameter values for performing the task, and wherein each channel specification comprises channel configuration data for configuring a physical channel of a device for use in performing the task.

6. The medium of claim 1, wherein, in comprising the task specification, the graphical program node comprises a reference to the task specification.

7. The medium of claim 1, wherein the code-generation function comprises a configuration code-generation function, and wherein said generating the at least a portion of the graphical program in accordance with the task specification comprises:
generating one or more interconnected graphical program nodes implementing programmatic generation of the task specification.

8. The medium of claim 7, wherein the one or more interconnected graphical program nodes implementing programmatic generation of the task specification are operable to be included in a graphical program, wherein the graphical program is executable to perform the task in accordance with the programmatically generated task specification.

9. The medium of claim 1, wherein the code-generation function comprises an example code-generation function, and wherein said generating the at least a portion of the graphical program in accordance with the task specification comprises:
generating one or more interconnected graphical program nodes, wherein the graphical program node and the one or more interconnected graphical program nodes comprise a graphical program implementing the task in accordance with the task specification.

10. The medium of claim 9, wherein the program instructions are further executable to perform:
executing the graphical program to perform the task in accordance with the task specification using the specified hardware and/or software.

11. The medium of claim 10,
wherein the graphical program comprises a block diagram portion and a user interface portion.

12. The medium of claim 11,
wherein, during execution of the graphical program, the graphical user interface is displayed on a display of a first computer system and the block diagram executes on a second computer system.

13. The medium of claim 9, wherein the one or more interconnected graphical program nodes implementing the task comprise one or more of:
one or more function nodes;
one or more terminal nodes; and
one or more structure nodes.

14. The medium of claim 13, wherein the one or more function nodes comprise one or more of:
a read node for acquiring data from an external system or process;
a write node for writing data to the external system or process; and
an analysis node for analyzing data acquired during performance of the task.

15. The medium of claim 13, wherein the one or more structure nodes comprise one or more of:
a while loop;
a for loop;
a conditional; and
a case/switch structure.

16. The medium of claim 9, wherein the graphical program comprises a plurality of interconnected nodes that visually indicate functionality of the graphical program.

17. The medium of claim 9,
wherein the graphical program comprises a graphical data flow program.

18. The medium of claim 1, wherein the code-generation function comprises an example code-generation function and a configuration code-generation function, and wherein said generating the at least a portion of the graphical program in accordance with the task specification comprises:
generating one or more interconnected graphical program nodes implementing programmatic generation of the task specification; and
generating one or more interconnected graphical program nodes implementing the task in accordance with the task specification;
wherein the one or more interconnected graphical program nodes implementing programmatic generation of the task specification and the one or more interconnected graphical program nodes implementing the task comprise a plurality of interconnected graphical program nodes composing the graphical program.

19. The medium of claim 18, wherein the program instructions are further executable to perform:
encapsulating the graphical program in a single graphical program node, wherein the single graphical program node represents the functionality of the graphical program, and wherein the single graphical program node is executable to perform the task in accordance with the task specification.

20. The medium of claim 1, wherein said receiving user input to the graphical program node comprises:
receiving first user input to the graphical program node;
displaying a plurality of function options to the user, wherein each function option indicates a respective function; and
receiving second user input selecting the function.

21. The medium of claim 20, wherein said displaying a plurality of function options to the user comprises one or more of:
displaying a menu of the function options; and
displaying a dialog of the function options.

22. The medium of claim 1, wherein the task comprises one or more of:
an industrial automation function;
a process control function;
a test and measurement function; and
a simulation function.

23. The medium of claim 1, wherein the graphical program node comprises an un-configured node, and wherein the medium is further configured to perform:
receiving first user input to the un-configured node;
invoking a configuration tool in response to the first user input; and
receiving second user input to the configuration tool specifying the task, wherein the configuration tool configures the un-configured node in response to the second user input, thereby generating a task specification comprised in the configured node;
wherein said receiving user input to the graphical program node comprises receiving the user input to the configured node; and
wherein said generating at least a portion of a graphical program is performed in accordance with the generated task specification.

24. The medium of claim 1,
wherein the graphical program node comprises a first type of graphical program node, wherein the graphical program node encapsulates a first graphical program implementing the task in accordance with the task specification;
wherein the code-generation function comprises a graphical program node conversion function, and wherein said generating the at least a portion of the graphical program in accordance with the task specification comprises:
converting the first type of graphical program node into a second type of graphical program node, wherein the second type of graphical program node comprises the task specification, wherein the second type of graphical program node is operable to perform said receiving user input, and wherein the second type of graphical program node is operable to provide the task specification to other nodes in the graphical program to perform the task in accordance with the task specification.

25. The medium of claim 24, wherein the medium is further configured to perform:
storing a copy of the task specification in a database, wherein the stored copy of the task specification is accessible for use in other graphical programs.

26. The medium of claim 1, wherein the medium comprises a carrier medium which stores program instructions, wherein the program instructions are executable to perform said receiving, said invoking, and said performing.

27. The medium of claim 1, wherein the medium comprises a programmable hardware element.

28. The medium of claim 1,
wherein said invoking a code-generation function comprises invoking a code-generation function of a configuration tool; and
wherein said performing the code-generation function is performed by the configuration tool.

29. A method for generating a graphical program in a graphical programming language, the method comprising:
displaying a first graphical program node on a display device, wherein the graphical program node comprises a task specification that specifies hardware and/or software for performing a task;
receiving user input to the graphical program node invoking a code-generation function; and
performing the code-generation function, thereby programmatically generating at least a portion of a graphical program in accordance with the task specification, wherein the graphical program implements the task.

30. A carrier medium which stores program instructions, wherein the memory medium is comprised in a computer system including a display, wherein the program instructions are executable to perform:
displaying on the display a node, wherein the node comprises an associated task specification, wherein the task specification specifies a task to be performed;
receiving user input selecting a program generation feature of the node;
programmatically generating at least a portion of a graphical program based on the task specification, wherein said programmatically generating comprises displaying the at least a portion of the graphical program on the display, wherein the at least a portion of the graphical program is executable to implement at least a portion of the task.

31. A system, comprising:
means for receiving user input to a graphical program node, wherein the graphical program node comprises a task specification that specifies hardware and/or software for performing a task;
means for invoking a code-generation function in response to the user input; and
means for performing the code-generation function, thereby generating at least a portion of a graphical program in accordance with the task specification, wherein the graphical program implements the task in accordance with the task specification.

32. A system for generating a graphical program, the system comprising:
a processor;
a memory medium coupled to the processor; and
a display coupled to the processor and the memory medium;
wherein the memory medium stores program instructions which are executable to:
receive user input to a graphical program node, wherein the graphical program node comprises a task specification that specifies hardware and/or software for performing a task;
invoke a code-generation function in response to the user input; and
perform the code-generation function, thereby generating at least a portion of a graphical program in accordance with the task specification, wherein the graphical program implements the task in accordance with the task specification.
